(19) United States
(12) Patent Application Publication
(10) Pub. No.: US 2010/0027269 A1
(43) Pub. Date: Feb. 4, 2010

(54) EVEN LUMINANCE, HIGH HEAT DISSIPATION EFFICIENCY, HIGH POWER LED LAMP STRUCTURE

(76) Inventors: Wei-Hung LO, Taipei City (TW); Chi-Ruei Tsai, Taipei City (TW)

Correspondence Address: The Weintraub Group, P.L.C., 28580 Orchard Lake Road, Suite 140, Farmington Hills, MI, 48334, US

(21) Appl. No.: 12/241,668

(22) Filed: Sep. 30, 2008

(30) Foreign Application Priority Data
Jul. 29, 2008 (TW) 097213398

(51) Int. Cl. F21V 29/00

(52) U.S. Cl. 362/294; 362/373

(57) ABSTRACT

An even luminance, high heat dissipation efficiency, high power LED lamp structure includes an aluminum extrusion body, an aluminum die cast front casing and an aluminum die cast rear casing respectively provided at two distal ends of the aluminum extrusion body, a PC board mounted inside the aluminum extrusion body, LEDs mounted in different LED mounting faces of the PC board at different angles, an inner cover plate decorating the inside of the aluminum die cast front casing, a transparent outer cover covering the bottom side of the aluminum extrusion body and sealed with a water seal, and a retaining device fastened to the aluminum extrusion body to secure the transparent outer cover in place.

### BACKGROUND OF THE INVENTION

1. Field of the Invention

The present invention relates to LED lamps and more particularly, to an even luminance, high heat dissipation efficiency, high power LED lamp structure that is practical for mass production to reduce the cost.

2. Description of the Related Art

Conventional light fixtures commonly use incandescent lamp bulbs or high-voltage sodium (mercuric) lamp bulbs as light source means to give off light. However, these lamp bulbs have high power consumption, low luminance efficiency and environmental unfriendly characteristics. However, because these light sources emit light in all directions, reflector means is necessary to reflect light toward a specific direction for floodlight illumination. Therefore, the effective utility of light is low.

Further, high brightness LEDs (light emitting diodes) have the advantages of small size, low power consumption and long service life. Therefore, high brightness LEDs are currently regarded as the next generation light source for illumination.

Commercial high power LED lamps include four types. The first type uses a regular lampshell for conventional high power lamp and has LEDs be bonded to the inside of the lampshell so that the lampshell dissipates heat from the LEDs during operation of the LEDs. The second type has LEDs and a heat sink (aluminum extrusion) be incorporated into a LED light source module, and then uses a regular lampshell for conventional high power lamp to hold the LED light source module on the inside. The third type has considered the problem of LED heat dissipation before designing the lampshell so that the heat dissipation structure is visible from the outside. This design employs a conventional lampshell fabrication technique, i.e., an aluminum die casting technique to make a lampshell for high power LED lamp. The fourth type is based on LED heat dissipation considerations, employing an aluminum extrusion technique to make the lampshell for high power LED lamp.

The aforesaid four types of high power LED lamps are still not satisfactory in function and have drawbacks as follows: The first type of high power LED lamp uses a conventional lampshell for high power lamp without considering the problem of LED heat dissipation. Because the problem of LED heat dissipation is not taken into consideration, iron or aluminum is used for making the lampshell. However, iron has poor heat dissipation efficiency. When aluminum is selected, aluminum alloy 1000 series should be used for making the lampshell by means of employing a die casting technique. However, the die cast aluminum alloy lampshell has a low heat dissipation efficiency. Further, for the sake of beauty, the die cast aluminum alloy lampshell may be painted with a powder paint or coating with a layer of plastic coating. The powder paint or plastic coating makes dissipation of heat worse.

The second type of high power LED lamp has LEDs and a heat sink (aluminum extrusion) be incorporated into a LED light source module, and then uses a regular lampshell for conventional high power lamp to hold the LED light source module. It seems that the heat sink can dissipate heat from the LEDs. However, because the lampshell has a low heat dissipation efficiency, this second type of high power LED lamp encounters the same problems as the aforesaid first type.

The third type has considered the problem of LED heat dissipation before designing the lampshell, and the heat dissipation structure is visible from the outside. However, because the lampshell is made of aluminum alloy 1000 series by means of die casting, the heat dissipation efficiency of the lampshell is low. To provide a relatively greater heat dissipation surface area, much aluminum alloy material should be used. In consequence, the lampshell is heavy and big. Therefore, this is not a good choice. Further, for the sake of beauty, the lampshell may be coated with a layer of powder paint or coated with a layer of plastic coating, lowering the heat dissipation efficiency.

The fourth type of high power LED lamp is based on LED heat dissipation considerations, employing an aluminum extrusion technique to make the lampshell. Aluminum alloy series 5000 or 6000 is usually used for the advantage of excellent heat dissipation efficiency. However, because the lampshell is simply a tow-dimensional design, its structure is simple and monotonous. Therefore, the shape design of the lampshell cannot satisfy consumers.

Further, conventional high power LED light source designs have another common drawback, i.e., uneven luminance. Therefore, these high power LED light source signs cannot satisfy user's requirements or meet law requirements on lighting arrangements.

Therefore, it is desirable to provide a high power LED lamp structure that eliminates the aforesaid problems.

### SUMMARY OF THE INVENTION

The present invention has been accomplished under the circumstances in view. It is one object of the present invention to provide an even luminance, high heat dissipation efficiency, high power LED lamp structure, which has the lamp housing thereof formed of an aluminum die cast front casing, an aluminum die cast and an aluminum extrusion body, providing an enhanced heat dissipation efficiency and causing a sense of beauty. Further, the aluminum extrusion type body has a substantially M-shaped cross section (see FIG. 3) that facilitates LED optical design to provide even illumination. Further, this arrangement facilitates mass production to lower the cost.

It is another object of the present invention to provide an even luminance, high heat dissipation efficiency, high power LED lamp structure, which has the printed circuit board thereof provide multiple LED mounting faces for supporting LEDs at different angles to satisfy high power light source lighting arrangement.

To achieve these and other objects of the present invention, the even luminance, high heat dissipation efficiency, high power LED lamp structure comprises a front casing; a body, the body comprising a first end, a second end opposite to the first end, and an accommodation space, the first end being connected with the front casing; a rear casing, the rear casing comprising a first end connected to the second end of the body, a second end opposite to the first end of the rear casing, and a connection means provided at the second end of the rear casing; a printed circuit board mounted in the accommodation space inside the body; at least one light emitting diode installed in the printed circuit board for emitting light; a light transmissive outer cover fastened to a bottom side of the body and covered over the printed circuit board for output of light from the at least one light emitting diode; and a retaining device provided at a bottom side of the light transmissive outer cover to secure the light transmissive outer cover to the body, the retaining device comprising a connection means connected to the connection means of the rear casing.

### BRIEF DESCRIPTION OF THE DRAWINGS

FIG. 1 is an exploded view of an even luminance, high heat dissipation efficiency, high power LED lamp structure according to the present invention.

FIG. 2 is an elevational assembly view of the even luminance, high heat dissipation efficiency, high power LED lamp structure according to the present invention.

FIG. 3 is a schematic cross-sectional view of the body and printed circuit board of the even luminance, high heat dissipation efficiency, high power LED lamp structure according to the present invention.

### DETAILED DESCRIPTION OF THE PREFERRED EMBODIMENT

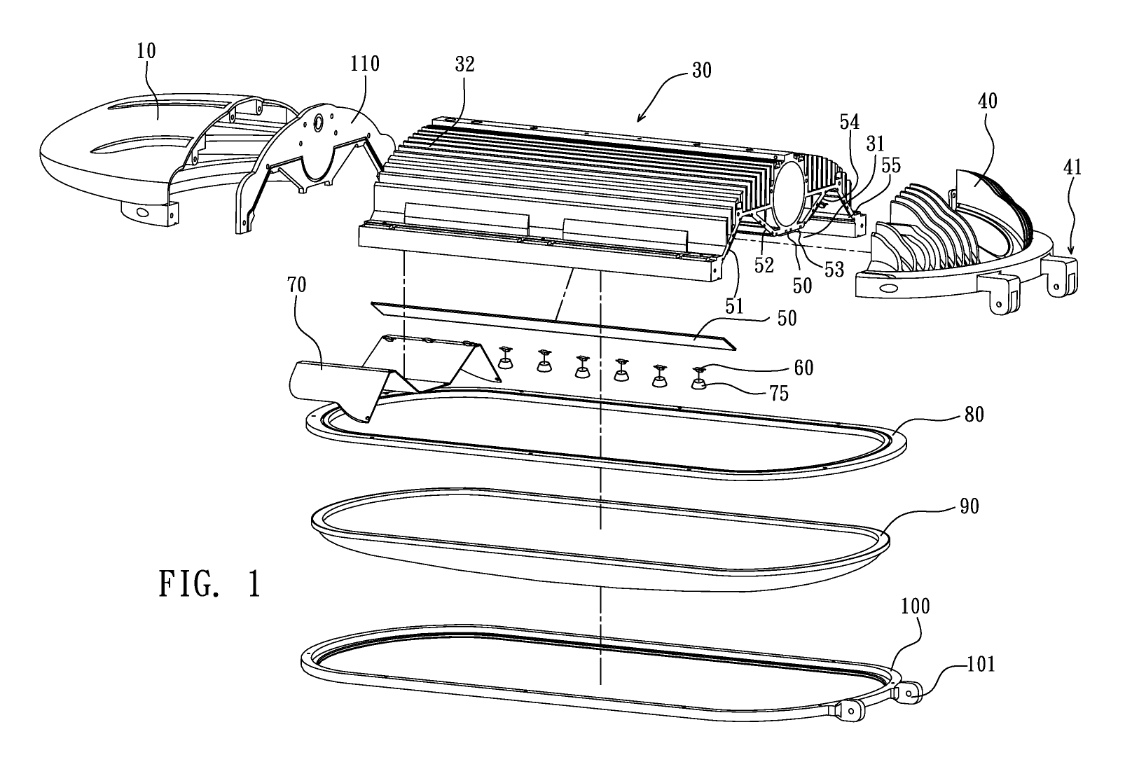

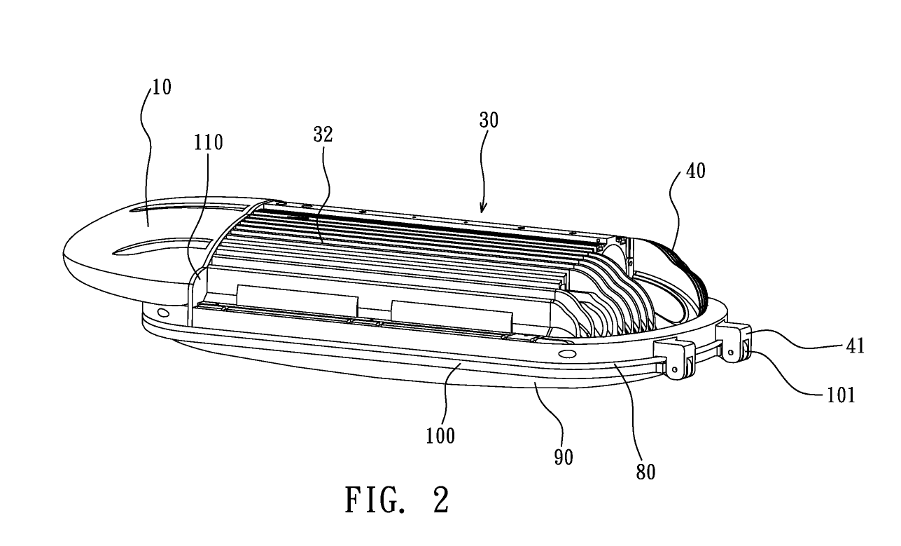

FIG. 1 is an exploded view of an even luminance, high heat dissipation efficiency, high power LED lamp structure according to the present invention. FIG. 2 is an elevational assembly view of the even luminance, high heat dissipation efficiency, high power LED lamp structure according to the present invention. As illustrated, the even luminance, high heat dissipation efficiency, high power LED lamp structure according to the present invention comprises a front casing 10, a body 30, a rear casing 40, a printed circuit board 50, at least one light emitting diode 60, an inner cover plate 70, at least one optical member 75, a water seal 80, a transparent outer cover 90, and a retaining device 100.

The front casing 10 can be, for example, but not limited, an aluminum die cast for the consideration of the shape design of the LED lamp structure. The heat dissipation efficiency of the aluminum die cast is not high. However, because the major part of the heat dissipation function of the LED lamp structure is done through the body 30, the front casing 10 needs not to have a heat dissipation function, and the LED lamp structure can be made having a three-dimensional configuration to satisfy consumers' demands and to facilitate the promotion of the LED lamp structure.

The body 30 has its one end connectable with the front casing 10 for heat dissipation. Further, the body 30 defines an accommodation space 31. The body 30 can be extruded from aluminum for the advantage of excellent heat dissipation efficiency. However, this is not a limitation. Further, radiation fins 32 are protruded from the outer wall of the body 30 to enhance heat dissipation.

The rear casing 40 has one end thereof connectable to the other end of the body 20, an opposite end thereof provided with a first connection means 41. The rear casing 40 can be, for example, but not limited, an aluminum die cast for the consideration of the shape design of the LED lamp structure. The heat dissipation efficiency of the aluminum die cast is not high. However, because the major part of the heat dissipation function of the LED lamp structure is done through the body 30, the rear casing 40 needs not to have a heat dissipation function, and the LED lamp structure can be made having a three-dimensional configuration to satisfy consumers' demands and to facilitate the promotion of the LED lamp structure. An aluminum die cast lampshell for high power LED lamp is heavy and big. Further, the manufacturing cost of an aluminum die cast lampshell for high power LED lamp is high. Therefore, the invention has the front casing 10 and rear casing 40 made of aluminum through a die cast technique, and the body 30 extruded from aluminum. Thus, the size of the LED lamp structure can be minimized to below one-third of original and the related tooling cost can be greatly reduced while, and the shape of the LED lamp structure can be made attractive.

The printed circuit board 50 can be, for example, but not limited to, an aluminum printed circuit board using an aluminum substrate and mounted in the accommodation space 31 inside the body 30. The printed circuit board 50 provides the necessary circuits for the light emitting diodes 60 and dissipates heat from the light emitting diodes 60 initially.

The light emitting diodes 60 are high-brightness LEDs for providing the necessary light source for illumination. The number of the light emitting diodes 60 can be changed subject to actual requirement.

The inner cover plate 70 is mounted inside the front casing 10 to beautify the internal arrangement.

The optical member 75 is for example but not limited to a lens or a light reflection cup, and disposed below the light emitting diodes 60 for changing the radiating angle of the light emitting diodes 60 and further for adjusting the light distributed curve, so as to meet the requirement.

The water seal 80 can be, for example, but not limited to, a rubber packing strip provided at the bottom side of the body 30 to prevent penetration of rainwater.

The transparent outer cover 90 is provided at the bottom side of the water seal 80 for output of the light source. The transparent outer cover 90 can be made of, for example, but not limited to glass or plastics.

The retaining device 100 is provided at the bottom side of the transparent outer cover 90, having a second connection means 101 for the connection of the first connection means 41.

The even luminance, high heat dissipation efficiency, high power LED lamp structure further comprises a gasket plate 110 set between the front casing 10 and the body 30 to prevent penetration of outside rainwater into the inside of the body 30, thereby protecting the internal printed circuit board 50 and the light emitting diodes 60.

The even luminance, high heat dissipation efficiency, high power LED lamp structure further comprises a power supply circuit (not shown) mounted, either wholly or partially, in the front casing 10 or on the outside the front casing 10, the body 30 and the rear casing 40, to provide the light emitting diodes 60 with the necessary working voltage. Because the power supply circuit design is of the known art and not within the scope of the claims of the present invention, no further detailed description in this regard is necessary.

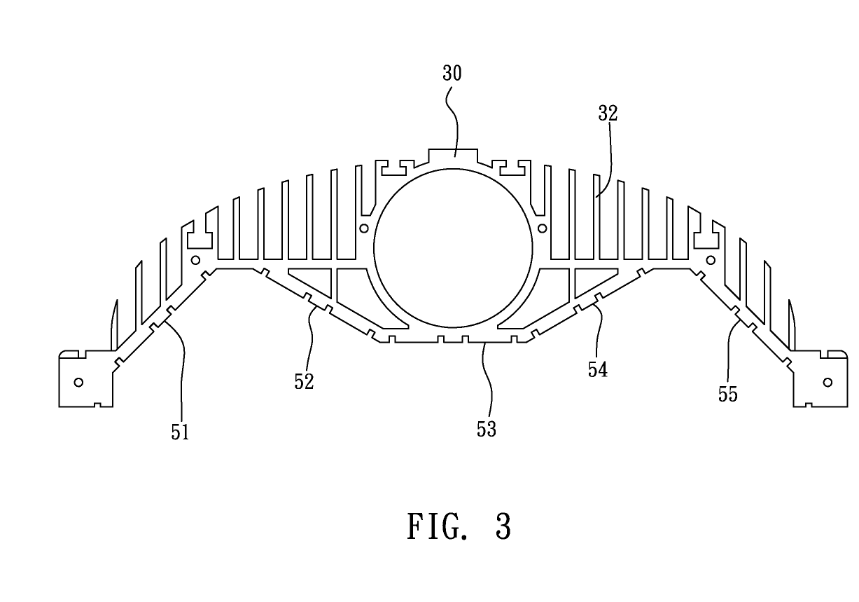

Thus, the front casing and rear casing of the even luminance, high heat dissipation efficiency, high power LED lamp structure are aluminum die cast members and the body is an aluminum extrusion component. When the front casing, the rear casing and the body are assembled together, they provide excellent heat dissipation efficiency. Further, the aluminum extrusion type body has a substantially M-shaped cross section (see FIG. 3) that facilitates LED optical design to provide even illumination. Further, this arrangement facilitates mass production to lower the cost. When compared to conventional high power LED lamp designs, the invention involves an inventive step.

FIG. 3 is a schematic cross-sectional view of the body and printed circuit board of the even luminance, high heat dissipation efficiency, high power LED lamp structure according to the present invention. As illustrated, the printed circuit board 50 has multiple LED mounting faces 51-55 disposed at different angles for holding LEDs at different angles. For example, the LED mounting faces 52 and 54 slope leftwards or rightwards at 30-degrees respectively; the LED mounting faces 51 and 55 slope rightwards or leftwards at 45-degrees respectively; the LED mounting faces 53 extends in horizontal.

Therefore, the even luminance, high heat dissipation efficiency, high power LED lamp structure of the present invention eliminates the drawbacks of the prior art designs and has advantages including: a) the arrangement of the aluminum die cast front casing and rear casing and aluminum extrusion body provides an enhanced heat dissipation efficiency, causes a sense of beauty, and lowers the manufacturing cost of the lamp structure, and b) the printed circuit board provides multiple LED mounting faces for supporting LEDs at different angles to satisfy high power light source lighting arrangement.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An even luminance, high heat dissipation efficiency, high power LED lamp structure, comprising:
a front casing;
a body, said body comprising a first end, a second end opposite to said first end, and an accommodation space, said first end being connected with said front casing;
a rear casing, said rear casing comprising a first end connected to the second end of said body, a second end opposite to the first end of said rear casing, and a connection means provided at the second end of said rear casing;
a printed circuit board mounted in said accommodation space inside said body; and
at least one light emitting diode installed in said printed circuit board for emitting light.

2. The even luminance, high heat dissipation efficiency, high power LED lamp structure as claimed in claim 1, wherein said front casing and said rear casing are aluminum die cast members.

3. The even luminance, high heat dissipation efficiency, high power LED lamp structure as claimed in claim 1, wherein said body is an aluminum extrusion member.

4. The even luminance, high heat dissipation efficiency, high power LED lamp structure as claimed in claim 1, further comprising an inner cover plate mounted in said front casing for decoration.

5. The even luminance, high heat dissipation efficiency, high power LED lamp structure as claimed in claim 1, further comprising a gasket plate set in between said front casing and said body to prevent penetration of rainwater into said body.

6. The even luminance, high heat dissipation efficiency, high power LED lamp structure as claimed in claim 1, further comprising water seal means peripherally sealed between said body and said light transmissive outer cover.

7. The even luminance, high heat dissipation efficiency, high power LED lamp structure as claimed in claim 6, further comprising a light transmissive outer cover fastened to a bottom side of said body and covered over said printed circuit board for output of light from said at least one light emitting diode.

8. The even luminance, high heat dissipation efficiency, high power LED lamp structure as claimed in claim 1, further comprising a retaining device provided at a bottom side of said light transmissive outer cover to secure said light transmissive outer cover to said body, said retaining device comprising a connection means connected to the connection means of said rear casing.

9. The even luminance, high heat dissipation efficiency, high power LED lamp structure as claimed in claim 1, wherein said printed circuit board is an aluminum printed circuit board formed of an aluminum substrate for providing circuit means for the installation of said at least one light emitting diode and for dissipating heat from said at least one light emitting diode.

10. The even luminance, high heat dissipation efficiency, high power LED lamp structure as claimed in claim 1, wherein said body comprises a plurality of radiation fins protruded from an outside wall thereof for heat dissipation.

11. The even luminance, high heat dissipation efficiency, high power LED lamp structure as claimed in claim 1, wherein said at least one light emitting diode each is a high power light emitting diode.

12. The even luminance, high heat dissipation efficiency, high power LED lamp structure as claimed in claim 7, wherein said light transmissive outer cover is a transparent cover selectively made of one of the materials of transparent glass and transparent plastics.

13. The even luminance, high heat dissipation efficiency, high power LED lamp structure as claimed in claim 6, wherein said water seal means is formed of a rubber packing strip and

14. The even luminance, high heat dissipation efficiency, high power LED lamp structure as claimed in claim 1, wherein said printed circuit board comprises a plurality of LED mounting faces disposed at different angles for supporting a plurality of light emitting diodes of said at least one light emitting diode at different angles.

15. The even luminance, high heat dissipation efficiency, high power LED lamp structure as claimed in claim 1, further comprising at least one optical member disposed below said light emitting diodes for changing the radiating angle of said light emitting diodes.

16. The even luminance, high heat dissipation efficiency, high power LED lamp structure as claimed in claim 15, wherein said optical member is a lens or a light reflection cup.
